(19) United States
(12) Patent Application Publication
(10) Pub. No.: US 2025/0135251 A1
(43) Pub. Date: May 1, 2025

(54) SMART FIRE BLANKET DEVICE, SYSTEM, AND METHOD

(71) Applicant: ENERGY STORAGE SAFETY PRODUCTS INTERNATIONAL LLC, Detroit, MI (US)

(72) Inventor: Ronald M. Butler, West Bloomfield, MI (US)

(21) Appl. No.: 18/933,055

(22) Filed: Oct. 31, 2024

Related U.S. Application Data
(60) Provisional application No. 63/594,824, filed on Oct. 31, 2023.

(51) Int. Cl. A62C 3/07; A62C 3/16; A62C 8/06; B60Q 1/52; B60Q 5/00; B60R 21/01

(52) U.S. Cl. CPC A62C 3/07; A62C 3/16; A62C 8/06; B60Q 1/52; B60Q 5/005; B60R 21/01; B60R 2021/01088

(57) ABSTRACT

The present disclosure provides a smart fire blanket device for detecting a thermal event of a vehicle. The smart fire blanket device can include a blanket and a detection module. The detection module can be coupled to the blanket and can include a sensor packet, a controller, a light source, an audio source, and a power source. The sensor packet can include a sensor for detecting the thermal event. The sensor can be adapted to monitor the thermal event associated with the vehicle and can detect heat, heat vented rise, humidity, pressure, and/or tilt of the vehicle. The controller can be in communication with the sensor packet and can be configured to receive and process data from the sensor packet. The light source can provide a visual alert. The audio source can provide an audio alert.

### CROSS-REFERENCE TO RELATED APPLICATIONS

This application claims the benefit of U.S. Provisional Application No. 63/594,824, filed on Oct. 31, 2024. The entire disclosure of the above application is incorporated herein by reference.

### FIELD

The present technology relates to fire blankets and, more particularly, a sensorized fire blanket device for detection of thermal events in battery powered products.

### INTRODUCTION

This section provides background information related to the present disclosure which is not necessarily prior art.

Fire safety devices include fire extinguishers, smoke detectors, and various sensors. Fire extinguishers are effective in suppressing fires, but they require manual operation and cannot always be readily accessible in emergency situations. Smoke detectors, on the other hand, are designed to detect smoke particles in the air, but they do not provide real-time information about the location or severity of a fire. Various sensors be used to detect heat or flames. Such sensors can include standalone sensors that are not integrated into a larger system. While these systems can provide early warning of a fire, standalone sensors lack the ability to actively respond to the fire and mitigate its spread.

With respect to vehicle fire safety, certain sensors can be used to monitor thermal events associated with vehicles. These sensors can detect changes in temperature, a rise in vented heat, humidity, pressure, and tilt of the vehicle, where these aspects can provide valuable information about potential fire hazards. However, these sensors are typically used for monitoring purposes only and do not include any active fire suppression capabilities.

Accordingly, there is a need for a smart fire blanket device, system, and method that allows for real-time monitoring of thermal events associated with certain battery-containing products, such as certain vehicles (e.g., electric vehicles), and provides visual and audio alerts to alert occupants and/or nearby individuals of a fire, while also providing a temperature resistant blanket for fire suppression.

### SUMMARY

In concordance with the instant disclosure, a smart fire blanket device, system, and method that allows for real-time monitoring of thermal events associated with products such as vehicles and provides visual and audio alerts, while also providing a temperature resistant blanket for fire suppression, has surprisingly been discovered. The present technology includes articles of manufacture, systems, and processes that relate to smart fire blankets.

The present disclosure provides a smart fire blanket device for detecting a thermal event of a product. The smart fire blanket device can include a blanket and a detection module. The blanket can be formed from a temperature resistant material. The detection module can be coupled to the blanket and can include a sensor packet, a controller, a light source, an audio source, and a power source. The sensor packet can include a sensor for detecting the thermal event. The sensor can be adapted to monitor the thermal event associated with the product and can include one or more sensors for detecting heat, heat vented rise, humidity, pressure, and tilt of the product. The controller can be in communication with the sensor packet and can be configured to receive and process data from the sensor packet. The light source can be in communication with the controller and can be configured to provide a visual alert. The audio source can also be in communication with the controller and can be configured to provide an audio alert. The power source can supply power to the detection module.

The present disclosure provides a system for detecting the occurrence of a thermal event. The system can include the smart fire blanket device, as described herein. The system can also include a user device in communication with the smart fire blanket device. The user device can be configured to receive a signal indicative of an alert from the smart fire blanket device.

The present disclosure also provides a method for detecting a thermal event. The method can include providing the smart fire blanket device described herein and providing a product at risk of the thermal event. The method can include placing the smart fire blanket device over the product and monitoring the product with the smart fire blanket device. The smart fire blanket device can alert a user in case of the thermal event being detected during the monitoring of the product.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a smart fire blanket device installed on a vehicle;

FIG. 2 is a top plan view of the smart fire blanket device including a detection module and a sensor housing, installed on the vehicle;

FIG. 3 is a top plan view of the sensor housing including a light source and an audio source;

FIG. 4 is a side elevational view of the sensor housing including the light source and the audio source;

FIG. 5 is a side elevational view of the sensor housing including the light source and the audio source coupled to a blanket of the smart fire blanket device;

FIG. 6 is a schematic depiction of a smart fire blanket device;

FIG. 7 is an environmental view of a thermal event occurring with a product, while the product is being monitored with a system for detecting the occurrence of the thermal event;

FIG. 8 is a schematic of a system for detecting the occurrence of a thermal event; and

FIG. 9 is a flowchart depicting a method for detecting the occurrence of a thermal event.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for case of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

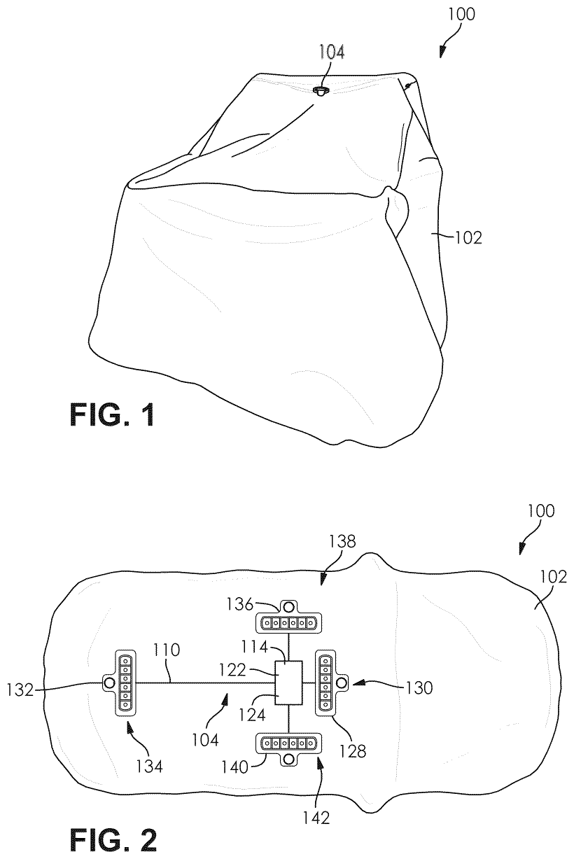

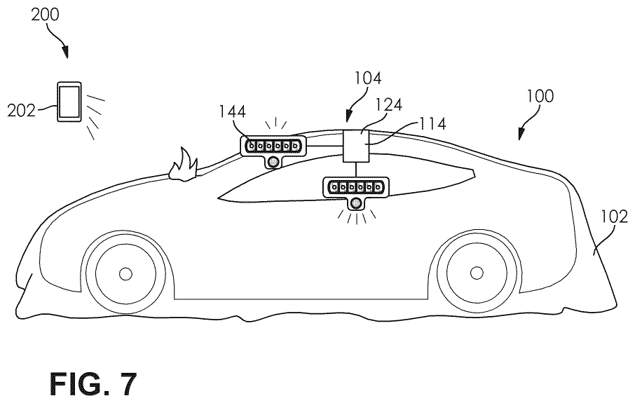

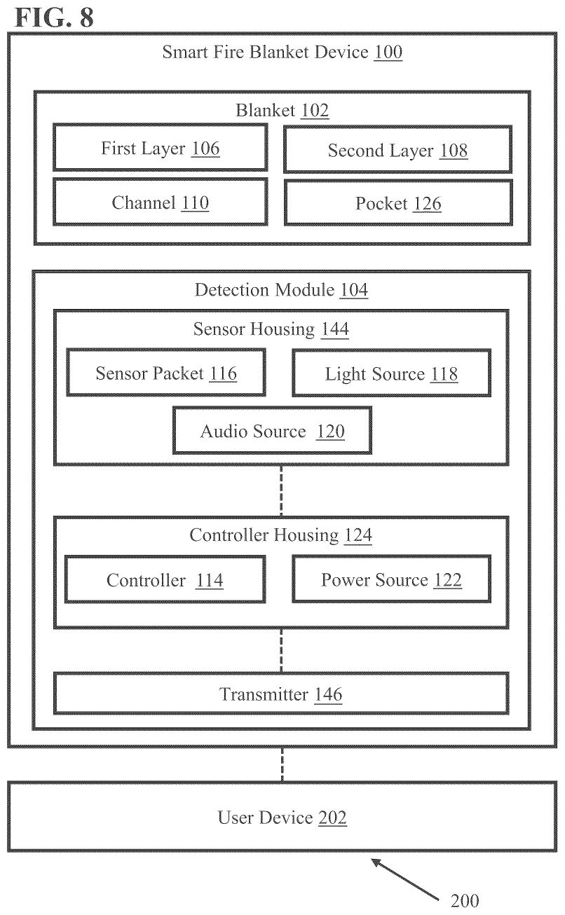

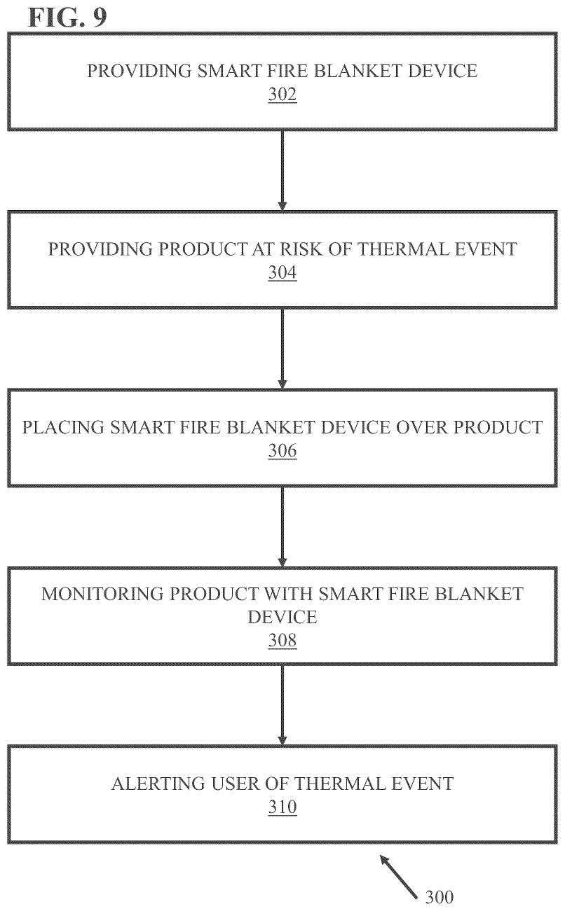

The present technology provides ways of making and using a smart fire blanket device for detecting a thermal event of a product, thereby militating against fire in products at risk of thermal events, such as battery-powered vehicles. A smart fire blanket device 100 for detecting a thermal event of a product is provided, as shown generally in FIGS. 1-6, a system 200 for militating against the occurrence of a thermal event is provided, as shown generally in FIGS. 7-8, and a method 300 for militating against occurrence of a thermal event is provided, as shown generally in FIG. 9. The present technology provides early detection of potential thermal events through advanced sensors that can monitor heat, humidity, pressure, and product tilt. The smart fire blanket device 100 can combine active detection with passive fire suppression via a temperature-resistant blanket that covers the entire product.

As used herein, the term “product” can be defined as any tangible item created to meet a specific consumer need or demand. In certain embodiments, the product can be a vehicle. Examples of vehicles include cars, trucks, buses, motorcycles, electric bicycles, trains, golf carts, segways, personal transporters such hoverboards. The vehicle can include vehicles powered in various ways, including hybrid electric vehicles, fully electric vehicles, and vehicles including one or more types of various batteries for supplying electric power.

As used herein, the term “thermal event” refers to any occurrence or process that involves a significant change in temperature or heat transfer, which can include physical phenomena like phase changes, chemical reactions that release or absorb heat, or events related to thermal runaway in a battery or other systems. As an example, the thermal event can include a failure of a battery of a product and a subsequent occurrence of a fire.

With reference to FIG. 2, the smart fire blanket device 100 for detecting a thermal event of a product can include a blanket 102 and a detection module 104. The blanket 102 can be formed of a temperature resistant material and can be customized to be formed in various sizes and shapes to accommodate different products at risk of thermal events. Customization of the blanket 102 can allow the smart fire blanket device 100 to be tailored to fit not only vehicles of different dimensions, but also other products containing a battery that require fire protection. The temperature-resistant material used can be cut, sewn, or molded to conform to the specific contours and dimensions of the product it is intended to protect. The adaptability allows for the smart fire blanket device 100 to provide comprehensive coverage, whether the smart fire blanket device 100 is being used on a compact car, a large truck, or even nontraditional vehicular items containing a battery such as scooters or hoverboards. The ability to tailor the size and the shape of the smart fire blanket device 100 allows for optimal placement of the detection module 104 components can increase effectiveness in monitoring and responding to a thermal event.

As shown in FIG. 5, the blanket 102 can be formed with multiple layers. For example, the blanket 102 can be formed from a first layer 106 and a second layer 108. The first layer 106, which can be disposed adjacent to the product and thus closest to a thermal event, can be made from a highly heat-resistant material. For example, the first layer 106 can be made from fiberglass or a carbonized fiber fabric. The first layer 106 can be lightweight and flexible, allowing the blanket 102 to easily be moved onto the product and off of the product, particularly in the case of a thermal event. The first layer 106 can withstand a thermal event producing temperatures up to about 1000° C. The purpose of the first layer 106 can be to provide immediate protection and containment of the thermal event. As an example, the first layer 106 can include a carbonized fiber fabric welding blanket commercially available as VELVET SHIELD® by Steiner Industries of Chicago, IL.

With continued reference to FIG. 5, the second layer 108 can be disposed adjacent the first layer 106 and can be an outer layer of the blanket 102 disposed away from the product. The second layer 108 can include the same material as the first layer 106 or, alternatively, the second layer 108 can include a different material than the first layer 106. The second layer 108 can be made from a highly heat-resistant material. The second layer 108 can be formed from a rigid and durable material providing structural stability to the blanket 102, particularly during a thermal event. The second layer 108 can withstand a thermal event producing temperatures up to about 1000° C. The purpose of the second layer 108 is to provide secondary protection and additional insulation during the thermal event to stop the thermal event from spreading. As an example, the second layer 108 can include a HI TEMP Welding Blanket sold by HI-TEMP PRODUCTS of Danbury, CT.

In certain embodiments, the blanket 102 can include a channel 110 formed within the blanket 102, such as a sewn tube, a fold, or a flexible and temperature resistant network, to accommodate wiring and connections between the various components of the detection module 104. The blanket 102 can include multiple channels to accommodate multiple detection modules 104 including wiring, sensors, light sources, and audio sources. The channel 110 can allow for strategic positioning of sensors throughout the smart fire blanket device 100, enabling comprehensive monitoring of different areas of the product and enhancing the ability of the fire blanket 102 to detect thermal events early. Additionally, the channel 110 can serve as a communication pathway between different components of the detection module 104.

As shown in FIGS. 2-5, the smart fire blanket device 100 can include the detection module 104 coupled to the blanket 102. The detection module 104 can include a controller 114, a sensor packet 116, a light source 118, an audio source 120, and a power source 122. The detection module 104 can provide monitoring through the sensor packet 116, which can be capable of detecting various indicators of thermal events such as heat, humidity, pressure, and product tilt. The real-time data processing capabilities of the detection module 104 allow for quick analysis and response to potential fire hazards. An alert operability, which can include visual notification via the light source 118 and/or audio notification via the audio source 120, facilitates immediate local awareness of detected issues.

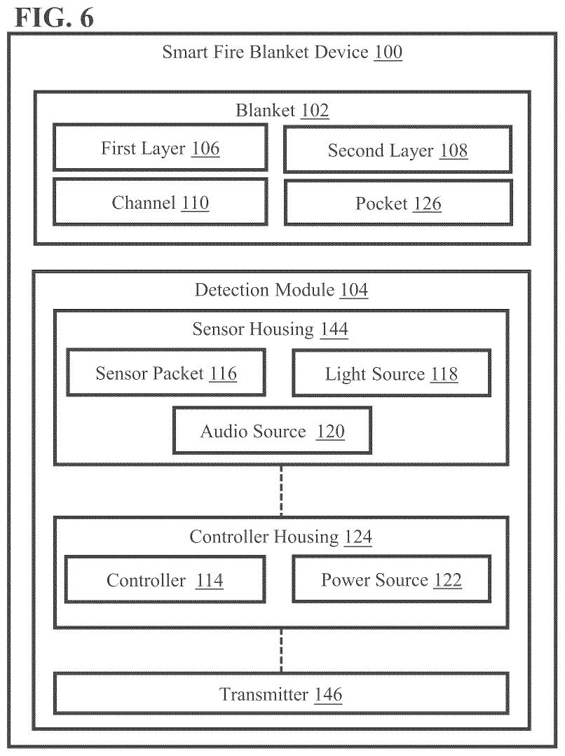

With reference to FIG. 6, the detection module 104 can include a controller housing 124 for containing the controller 114 and the power source 122. The blanket 102 can include a pocket 126 for storing the controller housing 124 in operation. By storing the controller housing 124 in the pocket 126 during use, the controller housing 124 can be protected from the thermal event by the first layer 106 and the second layer 108 of the blanket 102. It should be noted, however, that the controller housing 124 can be formed of a rigid material. As an example, the controller housing 124 can be formed using a rigid material having an IP66 rating. An IP66 rating is part of the International Protection (IP) code, which classifies the degrees of protection provided by enclosures for electrical equipment against intrusion, dust, and water. This rating signifies that the controller housing 124 can be completely dust-tight, offering maximum protection against dust particles, and can withstand powerful water jets from any direction without water ingress, making it highly resistant to water, which can be useful during extinguishing of a thermal event to improve the lifespan of the detection module 104 for reuse. For example, the controller housing 124 can be formed of stainless steel or aluminum, or even high-quality plastics like polycarbonate or acrylonitrile butadiene styrene (ABS). Additionally, the controller housing 124 can be sealed using rubber or silicone gaskets, which provide a watertight and dustproof seal. A skilled artisan can select a suitable type of material for the controller housing 124 within the scope of the present disclosure. By protecting the controller housing 124 and therefore, the controller 114 and the power source 122, the detection module 104 can provide an alert for a longer period of time before being potentially destroyed by the thermal event, thereby providing the user with adequate notification time and allowing a more probable response.

With continued reference to FIG. 6, the detection module 104 can include the sensor packet 116. The sensor packet 116 can include one or more sensors capable of detecting a thermal event and monitoring for a thermal event associated with the product. Specifically, the sensor packet 116 can include one or more sensors for detecting heat, heat vented rise, smoke, humidity, pressure, and tilt of the vehicle. The sensor within the sensor packet 116 can work together to provide comprehensive environmental monitoring, allowing the smart fire blanket device 100 to detect potential fire hazards or battery failures before the event escalates into a dangerous situation. The ability to monitor multiple parameters simultaneously can increase the sensitivity and accuracy of the smart fire blanket device 100 in identifying thermal events.

The sensor packet 116 can be capable of detecting heat such that the sensor can detect changes in heat, specifically temperature increases or when the temperature exceeds a predetermined value. The controller 114, which can be communication with the sensor packet 116, can be programmed with a predetermined temperature threshold. When the sensor relays information to the controller 114 indicating that the threshold has been exceeded, the controller 114 can activate the alert system, including both visual and audio alerts. For example, if the temperature sensed by the sensor exceeds about 60° C., the controller 114 can be programmed to trigger an alert. As another example, the controller 114 can alert where a temperature differential of about 20° C. occurs within a given time period, such as about 2 seconds, which can signify thermal runaway. The predetermined thresholds can allow the smart fire blanket device 100 to respond quickly to potential thermal events, providing early warning to users through the light source 118 and audio source 120. A skilled artisan can select a suitable predetermined temperature and suitable predetermined temperature differential within the scope of the present disclosure.

The sensor packet 116 can detect changes in heat vented rise, specifically the rate at which heat is rising. The controller 114, which is in communication with the sensor packet 116, can be programmed with a predetermined threshold for heat vent rise. When the sensor relays information to the controller 114 indicating that the predetermined threshold has been exceeded, the controller 114 can activate the alert system, including both visual and audio alerts.

The smart fire blanket device 100 can incorporate a smoke detector as part of the sensor packet 116 to detect smoke, which can be an indicator of a potential fire or thermal event. The smoke detector can be a photoelectric smoke detector, an ionization smoke detector, or a combination thereof. A photoelectric smoke detector uses a light source and a photocell sensor. When smoke enters the sensing chamber, it scatters the light beam, causing some of the light to hit the photocell, which then triggers the alarm. A photoelectric smoke detector can be generally more responsive to smoldering fires. An ionization smoke detector, on the other hand, uses a small amount of radioactive material to ionize the air between two electrically charged plates. When smoke enters the chamber, it disrupts the ionization and reduces the current flowing between the plates, which can relay to the controller 114 to trigger the alert system. The ionization smoke detector can be more responsive to flaming fires. A skilled artisan can select a suitable smoke detector within the scope of the present disclosure.

The sensor packet 116 can also detect humidity and a change in humidity. The controller 114, which is in communication with the sensor packet 116, can be programmed with a predetermined threshold for humidity differential. When the sensor relays information to the controller 114 indicating that the predeterminer threshold has been exceeded, the controller 114 can activate the alert system, including both visual and audio alerts. Monitoring the humidity of the area around the product can indicate a thermal event. Specifically, a battery experiencing a thermal event, can lead to changes in humidity, albeit indirectly. When the battery overheats, the battery can release gases or vapors, which can include moisture, thus increasing humidity in the surrounding area. While the thermal event itself might not directly change humidity, the consequences can influence moisture levels in the environment.

For example, if the rate of humidity change detected by the sensor exceeds the predetermined threshold, such as humidity rising by about 10% to about 20% percentage increase per minute, the controller 114 can be programmed to trigger an alert. A skilled artisan can select a suitable predetermined threshold within the scope of the present disclosure.

The sensor packet 116 can detect pressure and, specifically, can detect a change in pressure. The controller 144 can be programmed with a predetermined threshold for pressure differential. When the sensor relays information to the controller 114 indicating that the predetermined threshold has been exceeded, the controller 114 can activate the alert system, including both visual and audio alerts. For example, if the rate of pressure change detected by the sensor exceeds the predetermined threshold, such as increasing at a rate of about 127 kPa per minute, the controller 114 can trigger an alert.

The sensor packet 116 can detect the tilt of the product at a predetermined angle of movement. The controller 114 can be programmed with the predetermined threshold angle that triggers an alert. The predetermined threshold angle can be carefully calibrated to be large enough to avoid false alarms from minor environmental tilts, such as someone leaning on the product, but small enough to detect a significant tilt that could be indicative of a thermal event. The predetermined threshold angle can include an angle between about 15° to about 20° from the normal position of the product. A skilled artisan can select a suitable predetermined angle threshold within the scope of the present disclosure.

It should be appreciated that the controller 114 can be configured to make determinations based on a combination of sensor data collected by the sensor packet 116. The configuration allows for more accurate detection of thermal events while militating against the likelihood of false alarms. For example, the controller 114 can be programmed to require at least two of the predetermined thresholds to be met before triggering the alert system. By utilizing data from multiple sensors simultaneously, such as temperature, humidity, pressure, and tilt, the controller 114 can perform a more comprehensive analysis of the condition of the product. The multi-factor approach enhances the reliability of the detection system, as it militates against a single anomalous reading triggering an unnecessary alert. For instance, a slight increase in temperature alone might not necessarily indicate a thermal event, but if accompanied by a rapid change in pressure or an unusual tilt angle, it could more reliably suggest a potential hazard.

The sensor packet 116 can be adaptable and can be strategically positioned within the blanket 102 to be disposed adjacent to one or more particular points on a vehicle, as shown in FIG. 2. In certain embodiments, a first sensor packet 128 can be disposed on a first portion 130 of the blanket 102 that is positioned adjacent to a central top portion of the front windshield of the vehicle while installed on the vehicle. A second sensor packet 132 can be disposed on a second portion 134 of the blanket 102 that is positioned adjacent to a central top portion of the rear windshield of the vehicle while installed on the vehicle. A third sensor packet 136 can be disposed on a third portion 138 of the blanket 102 that is positioned adjacent to a driver side door window of the vehicle while installed on the vehicle. A fourth sensor packet 140 can be disposed on a fourth portion 142 of the blanket 102 that is positioned adjacent to a passenger side door window of the vehicle while installed on the vehicle. Advantageously, aligning each sensor packet 116 with the front windshield, the rear windshield, the driver side door, and the passenger side door can align the sensor packets 116 with the areas of the car most likely to experience a thermal event. Because heat rises, any thermal event experienced by the product will cause heat to move to an uppermost portion of the cover, where the sensor packet 116 can be positioned. In this way, the positioning of the sensor packet 116 allows for quick detection of environmental changes that can indicate a thermal event. It should be appreciated that the sensor packet 116 can be housed in a sensor housing 144, as shown in FIG. 4, which can be disposed at each of the positions described hereinabove for placing the sensor packet 116.

It should be appreciated that the sensor housing 144 can include a portion having the sensor packet 116 disposed through the blanket 102 adjacent to the first layer 106, as shown in FIG. 5. In this way, the sensor packet 116 can be disposed adjacent the product where the thermal event can occur and therefore, provide faster detection of thermal event. The sensor housing 144 can have separate portions having the light source 118 and the audio source 120 disposed on an outside of the second layer 108 of the blanket 102 to militate against the visual alert produced by the light source 118 and the audio alert produced by the audio source 120 from begin muffled, blocked, or inhibited by the blanket 102.

Where the sensor packet 116 is placed away from the edge of the blanket 102, such as near the uppermost portion or, rather, closer to a center of the blanket 102, the sensor packet 116 can be in wired communication with the controller 114. The wired communication can utilize the channel 110 of the blanket 102 to allow for communication between the sensor packet 116 and the controller 114 even during a thermal event. As described herein, the channel 110 can be formed of heat-resistant material such that even during a thermal event, the wired communication between the sensor packet 116 and the controller 114 is maintained. Alternatively, the sensor packet 116 and the controller 114 can be in wireless communication.

It should be appreciated that the data collected by the sensor packet 116, including data pertaining to heat, heat vented rise, humidity, pressure, and tilt of the product, can be sent to the controller 114 within the detection module 104 for processing and analysis. Real-time data processing can allow for quick identification of potential fire hazards, allowing for rapid response and alert generation.

As an example, the controller 114 can include a DNOC unit configured for detection (D), notification (N), operations (O), and communication (C). The controller 114 can coordinate and manage various functions of the smart fire blanket device 100, including data analysis to identify potential thermal events or fire hazards, alert triggering to activate the light source and audio source for visual and audio alerts, communication management for transmitting alert signals to external user devices when remote communication is enabled, and power management to ensure efficient operation of all components within the detection module 104.

It should be appreciated that the controller 114 can include a memory (internal or external), which can be coupled to one or more processors for storing information and instructions that can be executed by the processor. The memory can be one or more memories and of any type suitable to the local application environment and can be implemented using any suitable volatile or nonvolatile data storage technology such as a semiconductor-based memory device, a magnetic memory device and system, an optical memory device and system, fixed memory, and removable memory. For example, the memory can consist of any combination of random-access memory (RAM), read only memory (ROM), static storage such as a magnetic or optical disk, hard disk drive (HDD), or any other type of non-transitory machine or computer readable media. The instructions stored in the memory can include program instructions or computer program code that, when executed by the process, enable the at least smart fire blanket device 100 to perform tasks as described herein.

One skilled in the art will also appreciate that one or more processors can be configured for processing information and executing instructions or operations. The processor can be any type of general or specific purpose processor. In some cases, multiple processors for the at least one processor can be utilized according to other embodiments. In fact, the one or more of the processors can include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more of the processor can be remote from the smart fire blanket device 100, such as disposed within a remote platform.

The one or more processors can perform functions associated with the operation of the smart fire blanket device 100 which can include, for example, precoding of antenna gain/phase parameters, encoding and decoding of individual bits forming a communication message, formatting of information, and overall control of the one or more computing platforms, including processes related to management of communication resources.

The memory can also store a plurality of modules including the machine-readable instructions, which can be provided as tangible, non-transitory processor executable instructions, as a non-limiting example. The instructions can be configured to execute a method 300 of the present disclosure as described herein, by the processor or the other processors of the smart fire blanket device 100 as detailed hereinabove.

In certain embodiments, one or more computing platforms can also include or be coupled to one or more antennas (not shown) for transmitting and receiving signals and/or data to and from the smart fire blanket device 100. The one or more antennas can be configured to communicate via, for example, a plurality of radio interfaces that can be coupled to the one or more antennas. The radio interfaces can correspond to a plurality of radio access technologies including one or more of LTE, 5G, WLAN, Bluetooth, near field communication (NFC), radio frequency identifier (RFID), ultrawideband (UWB), and the like. The radio interface can include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

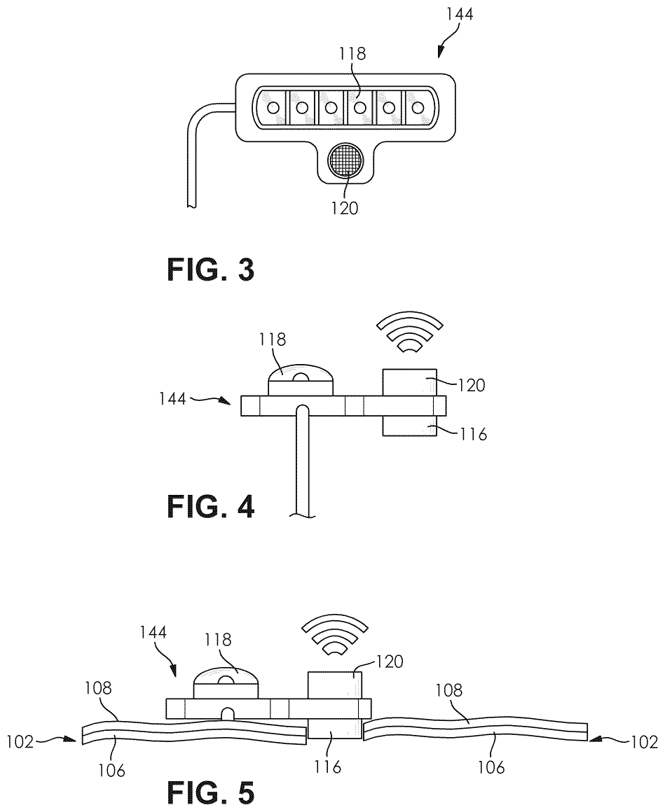

As shown in FIG. 6, the detection module 104 can include the light source 118, which can be in direct communication with the controller 114. The light source 118 can be disposed on the sensor housing 144 to allow for the light source 118 to be visible when in operation, as shown in FIGS. 2-3. Direct communication can allow the light source 118 to be activated promptly when the controller 114 processes data from the sensor packet 116 and determines that a thermal event is occurring. The light source 118 can provide a visual alert to nearby users or occupants when a thermal event is detected. In certain embodiments, the light source 118 can include an LED light that flashes or provides a strobe effect when providing the visual alert. The flashing nature of the LED light can increase visibility and draw immediate attention, even in potentially smoky or chaotic environments that might accompany a fire or thermal event. A skilled artisan can select a suitable type of light source 118 within the scope of the present disclosure.

With reference to FIG. 2, and as described herein, the light source 118 can be strategically positioned on the fire blanket to maximize the effectiveness of the visual alert. For example, the light source 118 can be disposed adjacent the first sensor pack 128 in the sensor housing 144 positioned adjacent to a central top portion of the front windshield of the vehicle, the second sensor pack 132 in the sensor housing 144 positioned adjacent to a central top portion of the rear windshield of the vehicle, the third sensor pack 136 in the sensor housing 144 positioned adjacent to a driver side door window of the vehicle, and/or the fourth sensor pack 140 in the sensor housing 144 positioned adjacent to a passenger side door window of the vehicle. Advantageously, positioning the light source 118 on adjacent the top portion of the car allows for the visual alert to be prominently displayed close to eye level and easily noticeable from various angles.

The light source 118 can work in conjunction with other components of the detection module 104. While the light source 118 provides visual alerts, the audio source 120 can provide an audio alert, creating a multi-sensory warning system. The combination of visual and audio alerts can increase the overall effectiveness of the smart fire blanket device 100 in notifying nearby individuals of a potential fire hazard.

With renewed reference to FIG. 2-3, the detection module 104 can include the audio source 120, which can be in direct communication with the controller 114. Direct communication can allow the audio source 120 to be activated promptly when the controller 114 processes data from the sensor packet 116 and determines that a thermal event is occurring. The audio source 120 can be disposed on the sensor housing 144. The audio source 120 can provide an audio alert to nearby users or occupants when a thermal event is detected. In certain embodiments, the audio source 120 can include a piezoelectric speaker providing the audio alert. Advantageously, the piezoelectric speaker can produce clear, attention-grabbing sounds, for effectively alerting nearby individuals in potentially noisy or chaotic environments that might accompany a fire or thermal event. The audio source 120 can be small and lightweight to make for easy integration into the blanket 102 without adding significant bulk or weight. Additionally, piezoelectric speaker can be resistant to temperature changes and humidity, which can occur during a thermal event. A skilled artisan can select a suitable type of audio source 120 within the scope of the present disclosure.

With reference to FIG. 2, and as described herein, the audio source 120 can be strategically positioned on the fire blanket to maximize the effectiveness of the visual alert. For example, the audio source 120 can be disposed adjacent the first sensor pack 128 positioned adjacent to a central top portion of the front windshield of the vehicle, the second sensor pack 132 positioned adjacent to a central top portion of the rear windshield of the vehicle, the third sensor pack 136 positioned adjacent to a driver side door window of the vehicle, and/or the fourth sensor pack 140 positioned adjacent to a passenger side door window of the vehicle. Advantageously, positioning the audio source 120 on adjacent the top portion of the car allows for the audio alert to be prominently broadcast and easily audible from various angles.

As shown in FIG. 6, the detection module 104 can include the power source 122 for supplying power to the detection module 104. The power source 122 can be disposed within the controller housing 124 to allow for the controller housing 124 to provide an additional layer of protection against the thermal event in addition to the first layer 106 and the second layer 108 of the blanket 102. Protecting the power source 122 from a thermal event can increase the longevity of the smart fire blanket device 100 and allow the power source 122 to operate continuously, even in situations where external power can be compromised.

The power source 122 can power all the components within the detection module 104, including the controller 114, the sensor packet 116, the light source 118, and the audio source 120. In certain embodiments, the power source 122 can include a battery for supplying power to the detection module 104. As an example, the battery can be a lithium-ion battery, a lithium polymer battery, an alkaline battery, a lithium iron phosphate (LiFePO₄) battery, or a sealed lead-acid battery. A skilled artisan can select a suitable power source 122 within the scope of the present disclosure.

The present disclosure further provides a system 200 for detecting the occurrence of a thermal event, shown generally in FIGS. 7-8. The system 200 can include the smart fire blanket device 100 as described herein, and a user device 202. The user device 202 can be in communication with the smart fire blanket device 100 and can be configured to receive a signal indicative of an alert from the smart fire blanket device 100. The user device 202 can serve as a remote interface for receiving alerts and notifications from the detection module 104. The user device 202 can extend the alert reach beyond the immediate vicinity of the vehicle or product being monitored.

As described herein, the detection module 104 can be configured to provide an audio and visual alert to a nearby user upon detecting an onset or occurrence of a thermal event. The detection module 104 can further include transmitter 146 in communication with the controller 114. The detection module 104 can be configured to transmit a signal by the transmitter 146 indicative of the detected thermal event to the user device 202. The communication allows for remote monitoring and rapid response to potential fire hazards, even when the user is not in close proximity to the smart fire blanket device 100.

As examples, the user device 202 can include a smart phone, smart watch, a tablet, networked computer, a laptop computer, a smart home device, a vehicle information system, an industrial control panel, a radio, a pager, a remote device dedicated to wireless communication with the smart fire blanket device 100, other various wirelessly connected devices, and combinations thereof. A skilled artisan can select a suitable user device 202 within the scope of the present disclosure.

By incorporating the user device 202, the effectiveness of the smart fire blanket device 100 can extend beyond just local alerts. The remote notification capability of the user device 202 can allow for quicker response times and potentially more effective mitigation of thermal events, as users can be alerted and take action even when they are not in the immediate vicinity of the monitored vehicle or product.

The present disclosure can also provide a method 300 for detecting the occurrence of a thermal event, shown generally in FIG. 9. The method 300 can include a step 302 of providing the smart fire blanket device 100 as described herein. The method 300 can include a step 304 of providing a product at risk of the thermal event. As described herein, the product can include a vehicle. The smart fire blanket device can be placed over the vehicle in a step 306. The method 300 can include a step 308 of monitoring the vehicle with the smart fire blanket device 100. In a step 310, the smart fire blanket device 100 can alert the user of a thermal even detected by monitoring the vehicle.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A smart fire blanket device for detecting a thermal event of a product, comprising:
a blanket including a temperature resistant material; and
a detection module coupled to the blanket, the detection module including
a sensor packet including a sensor for detecting the thermal event, the sensor being configured to detect a member selected from a group consisting of heat, heat vented rise, smoke, humidity, pressure, tilt of the product, and combinations thereof,
a controller in communication with the sensor packet, the controller configured to receive and process data from the sensor packet,
a light source in communication with the controller, the light source configured to provide a visual alert upon receiving an alert from the controller that the sensor has detected the thermal event,
an audio source in communication with the controller, the audio source configured to provide an audio alert upon receiving an alert from the controller that the sensor has detected the thermal event, and
a power source for supplying power to the detection module.

2. The smart fire blanket device of claim 1, wherein the detection module further includes a transmitter in communication with the controller and configured to transmit a signal indicative of an alert to a user device.

3. The smart fire blanket device of claim 2, wherein the detection module is configured to transmit a signal by the transmitter indicative of the thermal event to the user device including at least one of a mobile phone and a networked computer.

4. The smart fire blanket device of claim 1, wherein the blanket is tailored to fit a vehicle.

5. The smart fire blanket device of claim 4, wherein the sensor packet is disposed on a first portion of the blanket that is positioned adjacent to a central top portion of a front windshield of the vehicle while installed on the vehicle.

6. The smart fire blanket device of claim 5, wherein a second sensor packet is disposed on a second portion of the blanket that is positioned adjacent to a central top portion of a rear windshield of the vehicle while installed on the vehicle.

7. The smart fire blanket device of claim 6, wherein a third sensor packet is disposed on a third portion of the blanket that is positioned adjacent to a driver side door window of the vehicle while installed on the vehicle.

8. The smart fire blanket device of claim 7, wherein a fourth sensor packet is disposed on a fourth portion of the blanket that is positioned adjacent to a passenger side door window of the vehicle while installed on the vehicle.

9. The smart fire blanket device of claim 1, wherein the light source includes an LED light configured to flash.

10. The smart fire blanket device of claim 1, wherein the audio source includes a piezoelectric speaker.

11. The smart fire blanket device of claim 1, wherein the power source includes a battery.

12. The smart fire blanket device of claim 1, wherein the blanket includes a first layer and a second layer, the first layer formed from a different material than the second layer.

13. The smart fire blanket device of claim 1, wherein the blanket includes a channel formed within the blanket to accommodate wiring and connections between components of the detection module.

14. The smart fire blanket device of claim 1, wherein the detection module includes a controller housing for containing the controller and the power source.

15. The smart fire blanket device of claim 14, wherein the blanket includes a pocket for storing the controller housing in operation.

16. The smart fire blanket device of claim 1, wherein the sensor packet is housed in a sensor housing.

17. A system for detecting a thermal event of a product, comprising:
a smart fire blanket device including
a blanket including a temperature resistant material, and
a detection module coupled to the blanket, the detection module including
a sensor packet including a sensor for detecting the thermal event, the sensor being configured to detect a member selected from a group consisting of heat, heat vented rise, humidity, pressure, tilt of the product, and combinations thereof,
a controller in communication with the sensor packet, the controller configured to receive and process data from the sensor packet,
a light source in communication with the controller, the light source configured to provide a visual alert upon receiving an alert from the controller that the sensor has detected the thermal event,
an audio source in communication with the controller, the audio source configured to provide an audio alert upon receiving an alert from the controller that the sensor has detected the thermal event, and a power source for supplying power to the detection module; and
a user device in communication with the smart fire blanket device and configured to receive a signal indicative of an alert from the smart fire blanket device.

18. The system of claim 17, wherein the product is a vehicle having a battery.

19. A method for detecting a thermal event of a product, the method comprising steps of:
providing a smart fire blanket device including
a blanket including a temperature resistant material, and
a detection module coupled to the blanket, the detection module including
a sensor packet including a sensor for detecting the thermal event, the sensor being configured to detect a member selected from a group consisting of heat, heat vented rise, humidity, pressure, tilt of the product, and combinations thereof,
a controller in communication with the sensor packet, the controller configured to receive and process data from the sensor packet,
a light source in communication with the controller, the light source configured to provide a visual alert upon receiving an alert from the controller that the sensor has detected the thermal event,
an audio source in communication with the controller, the audio source configured to provide an audio alert upon receiving an alert from the controller that the sensor has detected the thermal event, and a power source for supplying power to the detection module;
providing the product;
placing the smart fire blanket device over the product;
monitoring the product with the smart fire blanket device; and
providing an alert upon detecting the thermal event while monitoring the product.

20. The method of claim 19, wherein the product is a vehicle having a battery.
